(19) United States
(12) Patent Application Publication
(10) Pub. No.: US 2009/0308666 A1
(43) Pub. Date: Dec. 17, 2009

(54) ANTI-ABRASION DEVICE FOR STYLUS INTEGRATED WITH ANTENNA AND ELECTRONIC APPARATUS USING THE SAME

(75) Inventors: Hung-Ta Huang, Taipei (TW); Ming-Chih Hsieh, Taipei (TW); Chung-Yuan Kuang, Taipei (TW); Tzung-Ye Wu, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASUSTEK COMPUTER INC., Taipei (TW)

(21) Appl. No.: 12/467,099

(22) Filed: May 15, 2009

(30) Foreign Application Priority Data
Jun. 16, 2008 (TW) 097122451

(51) Int. Cl. G06F 3/033; G08C 21/00

(52) U.S. Cl. 178/19.01; 178/18.01

(57) ABSTRACT

An anti-abrasion device for a stylus integrated with an antenna is applied to an electronic apparatus. The electronic apparatus includes a main body, the stylus, and a slot. The anti-abrasion device comprises an antenna-connecting unit, a switch unit and a blocking unit each of which is disposed in the main body, and the blocking unit is linked to the switch unit. When the stylus is inserted in the slot, the antenna-connecting unit touches the stylus; and when the switch unit is switched off, the blocking unit disconnects the stylus from the antenna-connecting unit.

### FIELD OF THE INVENTION

The present invention relates to an anti-abrasion device for a stylus integrated with an antenna, and more particularly to an anti-abrasion device for an integrated stylus applied to an electronic apparatus.

### BACKGROUND OF THE INVENTION

One of the main functions and characteristics of a personal digital assistant (thereafter referred as PDA) is to provide the user flexibility to look after day-to-day administration and to deal with personal affairs conveniently at any time and on any occasion without any restriction. Nowadays PDAs have been designed to provide various functions, such as word processor, file access and management, medium services (i.e., music, broadcasts and DVB-H mobile TV) and wireless network solution, with which a PDA is compatible to compete with a personal computer. In addition, a PDA has a small size for the users convenience to carry and can be connected to the various peripheral devices, such that a PDA is now regarded as a portable computer. Hence, PDAs provide recent users quite a lot of conveniences.

Referring to FIG. 1A, FIG. 1A illustrates a PDA 1 with digital video broadcasting-handheld (DVB-H) mobile TV functions. As depicted in FIG. 1A, the PDA 1 comprises a main body 10, a touch panel 11, a functional key 12, a stylus integrated with a DVB-H antenna 13 and a slot 14, wherein the touch panel 11 and the functional key 12 are disposed on the main body 10. Users can either select and operate the optional functions provided by the PDA 1 via the functional key 12 directly or select and operate the optional functions shown on the touch panel 11 via the stylus 13. Generally, a slot 14 is set on one side of the main body 10 to allow the users to insert the stylus 13 therein while the stylus 13 is idle. As depicted in FIG. 1B, when the stylus 13 is inserted in the slot 14, the stylus 13 touches an antenna-connecting metal leaf spring 15 disposed in the slot 14, by which the DVB-H antenna integrated within the stylus 13 can transmit and receive aerial signals. Thus while the stylus 13 is inserted in the slot 14, the users can receive TV signals and display TV programs via the PDA 1.

However, there have some drawbacks in regard to the construction of the aforementioned PDA 1. The cladding metal layer coated on the stylus 13 could be wear down by the friction between the stylus 13 and the antenna-connecting metal leaf spring 15 while the stylus 13 is inserted in to/pulled out of the slot 14 by the users. Therefore, the lifetime of the integrated stylus 13 should be shortened.

### SUMMARY OF THE INVENTION

One aspect of the present invention, an anti-abrasion device for a stylus integrated with an antenna applied to an electronic apparatus is disclosed. The electronic apparatus includes a main body, the stylus, and a slot. The anti-abrasion device comprises an antenna-connecting unit disposed in the main body, wherein when the stylus is inserted in the slot the antenna-coupling unit touches the stylus; a switch unit mounted on the main body; and a blocking unit disposed in the main body and linked to the switch unit and the antenna-connecting unit. When the switch unit is switched off, the blocking unit disconnects the stylus from the antenna-connecting unit.

Another aspect of the present invention, an electronic apparatus is disclosed, wherein the electronic apparatus comprises a main body having a slot; a stylus integrated with an antenna; an antenna-connecting unit disposed in the main body, when the stylus is inserted in the slot, the antenna-connecting unit touches the stylus; a switch unit mounted on the main body; and a blocking unit disposed in the main body and linked to the switch unit and the antenna-connecting unit. When the switch unit is switched off, the blocking unit disconnects the stylus from the antenna-connecting unit.

In accordance with the embodiments of the present invention, an anti-abrasion device is disposed on the main body of a PDA to prevent the stylus from rubbing against the antenna-connecting unit to cause abrasion. Before inserting or pulling the stylus, the antenna-connecting unit is separated from the stylus by switching off the switch unit. Hence, the friction between the stylus and the antenna-connecting unit is avoided.

### BRIEF DESCRIPTION OF THE DRAWINGS

The above objects and advantages of the present invention will become more readily apparent to those ordinarily skilled in the art after reviewing the following detailed description and the accompanying drawings, in which:

FIG. 1A is a schematic view showing a conventional PDA with DVB-H mobile TV functions;

FIG. 1B is a construction profile showing a stylus inserted in a slot of the PDA;

FIG. 2 is a construction profile showing an anti-abrasion device disposed in a PDA and a stylus inserted in the PDA according to a preferred embodiment of the present invention; and

FIG. 3A and FIG. 3B are the operation diagrams showing two operation states of the anti-abrasion device of FIG. 2.

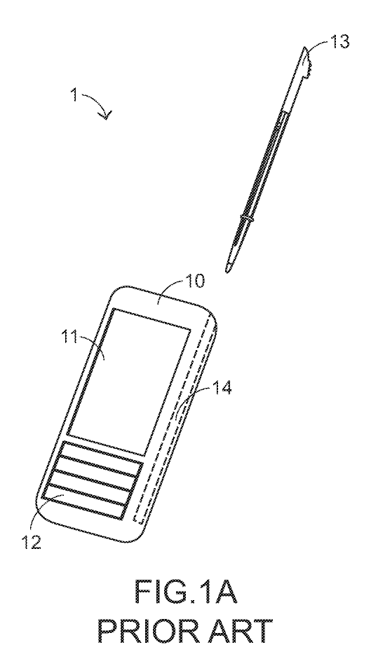

### DETAILED DESCRIPTION OF PREFERRED EMBODIMENTS

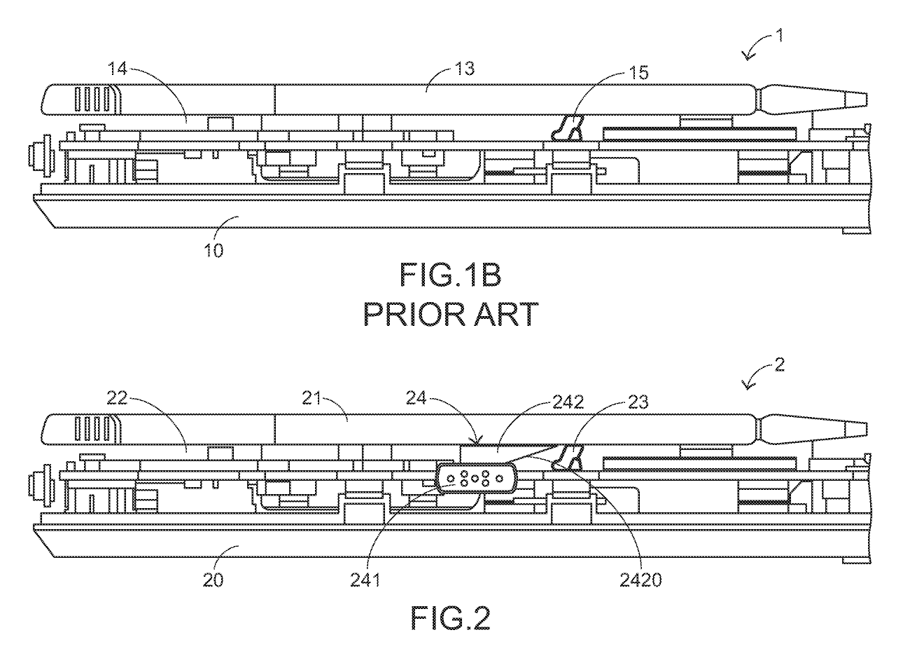

Referring to FIG. 2, illustrating an anti-abrasion device for a stylus integrated with an antenna in accordance with one embodiment of the present invention. In the present embodiment, the anti-abrasion device primarily is applied to a PDA. As depicted in FIG. 2, the PDA 2 that equips the anti-abrasion device 24 disclosed by the present embodiment comprises a main body 20, a stylus 21, a slot 22, an antenna-connecting unit 23 and the anti-abrasion device 24, wherein the slot 22 is set in the main body 20 to allow the stylus 21 inserted therein. Hence the stylus 21 is a bare stylus available for a general PDA integrated with a DVB-H antenna to render the bare stylus for receiving DVB-H signals (thereafter referred as an aerial function). Thus it is not necessary to dispose additional antennas on to the other portions of the PDA 2 so as to reduce the size of the PDA. Besides, since the antenna-connecting unit 23 is disposed in the main body 20, when the stylus 21 is inserted into the slot 22, the antenna-connecting unit 23 can be in contact with the stylus 21, meanwhile the aerial function of the stylus 21 can be enabled. Therefore, the users of PAD 2 can watch TV via the aerial function of the stylus 21 of receiving DVB-H TV signals.

As aforementioned, the conception of the present embodiments mainly is to equip an anti-abrasion device 24 on the main body 20 of the PDA 2 to prevent the stylus 21 from abrasion due to the unnecessary contact with the antenna-connecting unit 23 while the aerial function of the stylus 21 is not in use. The anti-abrasion device 24 comprises a switch unit 241 and a blocking unit 242, wherein the switch unit 241 is set on the main body 20 and used to turn on or off the aerial function of the stylus 21 in accordance with the demands made by the users of the PDA 2; and the blocking unit 242 is set in the main body 20 and linked to the switch unit 241. When the user wants to turn off the aerial function of the stylus 21 by the switch unit 241, the blocking unit 242 can be driven to lie in the way between the stylus 21 and the antenna-connecting unit 23; when the user wants to turn on the aerial function of the stylus 21 by the switch unit 241, the blocking unit 242 can be driven away to reconnect the stylus 21 and the antenna-connecting unit 23. Since the blocking unit 242 may serve as a barrier to disconnect the antenna-connecting unit 23 from the stylus 21 while the switch unit 241 turns off the aerial function of the stylus 21, thus when the users draws out the stylus 21 from the slot 22 to operate, abrasions due to the friction between the stylus 21 and the antenna-connecting unit 23 may not occur.

In accordance with the aforementioned description, the antenna-connecting unit 23 involved in the PDA 2 of the present invention is a leaf spring. Since the leaf spring is resilient, thus when the switch unit 241 turns off the aerial function of the stylus 21, the leaf spring should be deformed by the compression of the blocking unit 242, and the blocking unit 242 can be inserted between the antenna-connecting unit 23 and the stylus 21 to disconnect the stylus 21 from the antenna-connecting unit 23. In the present embodiment, the blocking unit 242 of the anti-abrasion device 24 has an incline structure 2420. When the switch unit 241 turns on or off the aerial function of the stylus 21, the incline structure 2420 slides against the antenna-connecting unit 23. Because of the resilience of the antenna-connecting unit 23, when the incline structure 2420 slides against the antenna-connecting unit 23, the antenna-connecting unit 23 can be deformed by the compression of the incline structure 2420 that varies in light of the thickness variation of the incline structure 2420 along the sliding direction. The use and operation of the anti-abrasion device 24 can be well appreciated as referring to the following description.

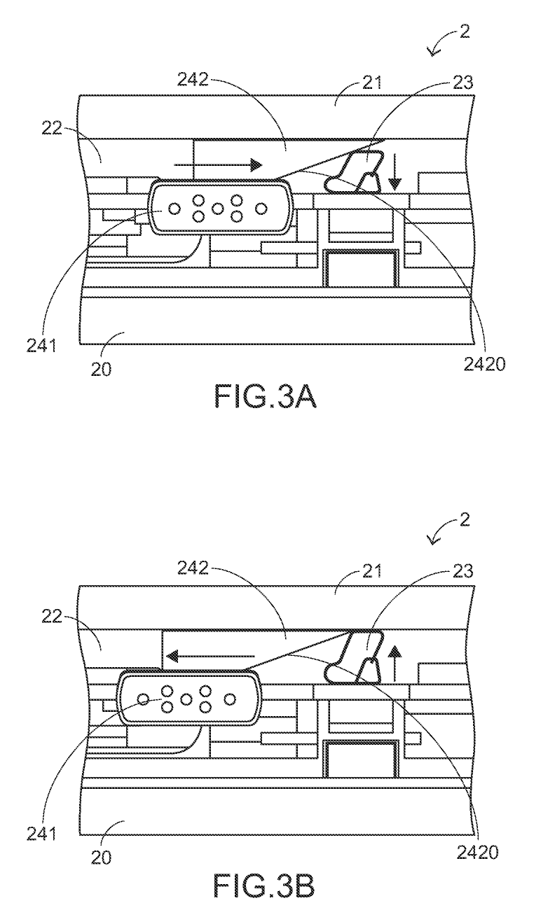

FIG. 3A and FIG. 3B are the operation diagrams of the anti-abrasion device of the PDA for the stylus integrated with an antenna in accordance with the aforementioned embodiment of the present invention. FIG. 3A depicts the operation process in turning off the aerial function of the stylus 21 via the switch unit 241. The switch unit 241 is pushed forward along the first direction (shown as the arrow illustrated in FIG. 3A), meanwhile the switch unit 241 drives the incline structure 2420 of the blocking unit 242 to move against the antenna-connecting unit 23. Hence the incline structure 2420 slides against the antenna-connecting unit 23. The incline structure 2420 is thinner and thinner along the first direction. When the incline structure 2420 is driven to move along the first direction, the antenna-connecting unit 23 can be deformed by the compression of the incline structure 2420 (see the downward arrow) to increase the gap between the stylus 21 and the antenna-connecting unit 23 so as to allow the blocking unit 242 to be inserted between the antenna-connecting unit 23 and the stylus 21 and to prevent the cladding metal layer coated on the stylus 21 from abrasion during the insert-draw mechanism to draw/put the stylus 21 out of/in to the slot 22.

Continued from the preceding description, as depicted in FIG. 3A, the blocking unit 242 is inserted between the antenna-connecting unit 23 and the stylus 21 so that the antenna-connecting unit 23 and the stylus 21 are disconnected. Thus the aerial function of stylus 21 is not available. However, when the users want to use the aerial function of stylus 21, what he/she should do is to push the switch unit 241 forward along the second direction (shown as the arrow illustrated in FIG. 3B) to drive the incline structure 2420 of the blocking unit 242 to release the antenna-connecting unit 23. When the blocking unit 242 is driven along the second direction, the thickness of the insert portion of the incline structure 2420 is decreasing. Thus, the compression by the incline structure 2420 is released to make the antenna-connecting unit 23 regaining its original shape gradually and reconnecting itself to the stylus 21 to recover the aerial function of stylus 21.

In accordance with the aforementioned description, the anti-abrasion device for the stylus integrated with an antenna of the present invention indeed can improve the conventional technology to resolve the drawbacks of the prior art to accomplish the major objects of the present invention. Besides the PDA, the anti-abrasion device of the present invention can be further utilized on a global position system and other electronic apparatus each has a stylus set thereon. As is understood by a person skilled in the art, it is intended to cover various modifications and similar arrangements included within the spirit and scope of the appended claims, the scope of which should be accorded the broadest interpretation so as to encompass all such modifications and similar structure.

What is claimed is:

1. An anti-abrasion device in use with a stylus integrated with an antenna and applied to an electronic apparatus including a main body, the stylus, and a slot, wherein the anti-abrasion device comprises:
an antenna-connecting unit, disposed in the main body, wherein when the stylus is inserted in the slot, the antenna-connecting unit touches the stylus;
a switch unit, mounted on the main body; and
a blocking unit, disposed in the main body and linked to the switch unit and the antenna-connecting unit, for disconnecting the stylus from the antenna-connecting unit when the switch unit is switched off.

2. The anti-abrasion device according to claim 1, wherein the antenna-connecting unit is a leaf spring.

3. The anti-abrasion device according to claim 1, wherein the blocking unit has an incline structure sliding against the antenna-connecting unit, whereby the antenna-connecting unit is deformed by the compression of the incline structure in the light of a thickness variation of the incline structure.

4. The anti-abrasion device according to claim 3, wherein the switch unit is pushed forward along a first direction to insert the incline structure between the antenna-connecting unit and the stylus to disconnect the antenna-connecting unit from the stylus.

5. The anti-abrasion device according to claim 3, wherein the switch unit is pushed forward along a second direction to drive the incline structure to release the antenna-connecting unit to connect the antenna-connecting unit with the stylus.

6. The anti-abrasion device according to claim 1, wherein the antenna integrated with the stylus is a digital video broadcasting-handheld (DVB-H) antenna.

7. An electronic apparatus, comprising
a main body, having a slot;
a stylus integrated with an antenna;
an antenna-connecting unit, disposed in the main body, wherein when the stylus is inserted in the slot, the antenna-connecting unit touches the stylus;
a switch unit, mounted on the main body; and
a blocking unit, disposed in the main body and linked to the switch unit and the antenna-connecting unit, for disconnecting the stylus from the antenna-connecting unit when the switch unit is switched off.

8. The electronic apparatus according to claim 7, wherein the antenna-connecting unit is a leaf spring.

9. The electronic apparatus according to claim 7, wherein the blocking unit has an incline structure sliding against the antenna-connecting unit, whereby the antenna-connecting unit is deformed by the compression of the incline structure in the light of a thickness variation of the incline structure.

10. The electronic apparatus according to claim 9, wherein the switch unit is pushed forward along a first direction to insert the incline structure between the antenna-connecting unit and the stylus to disconnect the antenna-connecting unit from the stylus.

11. The electronic apparatus according to claim 9, wherein the switch unit is pushed forward along a second direction to drive the incline structure to release the antenna-connecting unit to connect the antenna-connecting unit with the stylus.

12. The electronic apparatus according to claim 7, wherein the antenna integrated with the stylus is a digital video broadcasting-handheld antenna.
